(19) United States
(12) Patent Application Publication
(10) Pub. No.: US 2007/0248101 A1
(43) Pub. Date: Oct. 25, 2007

(54) EFFICIENT POLICER BASED WEIGHTED FAIR BANDWIDTH METHOD AND SYSTEM

(75) Inventor: Reuven ZEITAK, Rehovot (IL)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/736,577

(22) Filed: Apr. 17, 2007

(30) Foreign Application Priority Data
Apr. 20, 2006 (EP) 06 300 382.6

(51) Int. Cl. H04L 12/56

(52) U.S. Cl. 370/395.41; 370/412

(57) ABSTRACT

An efficient policer based weighted fairness bandwidth distribution system is disclosed. The system is based on a plurality of policers and a single queue. To achieve fairness, the rate for queuing packets is adaptively controlled. Specifically, first the queue occupancy is determined and it then is used for computing an attenuation (Attn) value. This value is multiplied by the excess information rate (EIR) of each policer to get a new EIR to be enforced.

### FIELD OF THE INVENTION

The invention is based on a priority application EP 06300382.6 which is hereby incorporated by reference.

The present invention relates generally to communication networks, and more particularly to techniques for queuing data traffic in communication networks.

Access to and use of wireless networks is becoming increasingly important and popular for business, social, and recreational purposes. Users of wireless networks now rely on them for both voice and data communications. Furthermore, an ever increasing number of users demand both an increasing array of services and capabilities as well as greater bandwidth for activities such as Internet surfing. To address and meet the demands for new services and greater bandwidth, the wireless communications industry constantly strives to improve the number of services and the throughput of their wireless networks. Expanding and improving the infrastructure necessary to provide additional services and higher bandwidth is an expensive and manpower-intensive undertaking. Moreover, high-bandwidth data streams will eventually be demanded by consumers to support features such as real-time audio-visual downloads and live audio-visual communication between two or more people. In the future, it will therefore become necessary and/or more cost-effective to introduce next generation wireless system(s) instead of attempting to upgrade existing system(s).

To that end, the wireless communications industry intends to continue to improve the capabilities of the technology upon which it relies and that it makes available to its customers by deploying next generation system(s). Protocols for a next-generation standard that is designed to meet the developing needs of wireless customers is being standardized by the 3.sup.rd Generation Partnership Project (3GPP). The set of protocols is known collectively as the Universal Mobile Telecommunications System (UMTS).

In the current state of the Internet, the issues of guaranteed bandwidth fairness and support for multiple levels of latency are becoming increasingly important. Guaranteed bandwidth fairness is typically provided using so called “Fair Queuing” algorithms. These algorithms guarantee that bandwidth of a certain link (or virtual link) is fairly apportioned among its various flows. Fair Queuing algorithms are incorporated into network systems using fair queuing (or bandwidth) schedulers. These schedulers seek to control congestion even in the presence of ill-behaved sources, so that a single source that sends packets to a gateway at a sufficiently high speed cannot capture an arbitrarily high portion of the bandwidth of the outgoing line. While providing bandwidth guarantees is important, it is also important that latency-critical traffic flows (such as Voice Over IP and Video) experience as low latency as possible. Prioritizing traffic flows so that latency-critical flows experience low latency is currently provided by priority (or latency) schedulers.

### BACKGROUND OF THE INVENTION

Conventional network solutions have attempted to resolve both fair queuing and priority scheduling, and, despite the inherent tension between the two concerns, have been somewhat successful in incorporating both features in network systems.

Weighted fair queuing (WFQ) is a well known flow-based queuing technique as for example disclosed in U.S. Pat. No. 6,810,426 or U.S. Pat. No. 6,850,540. The WFQ simultaneously schedules interactive traffic to the front of the queue to reduce response time and it fairly shares the remaining bandwidth between high bandwidth flows.

FIG. 1 shows in prior art a conventional WFQ system 100 that includes N queues 110-1 through 110-N. Each queue 110 serves a single source (or connection) and is assigned with a respective weight. Each packet leaving its respective queue 110 is forwarded directly to an output channel 120. The scheduling method implemented in WFQ system 100 ensures that the waiting time of packets in queues 110 is always in proportion to queue's weights.

For example, a WFQ system having three queues Q1, Q2, and Q3 and respectively assigned with the weights W₁=5, W₂=2, and W₃=3. The maximum allowable rate of the output channel is 10 MB/Sec. In this exemplary system, if all queues have packets waiting, then Q2 and Q3 receive a guaranteed bandwidth of 2 and 3 MB/Sec respectively, and Q1 receives a guaranteed bandwidth of 5 MB/sec. If Q1 does not have any packets waiting, then the excess bandwidth is equal to 5 MBS/second. In a WFQ system, this excess bandwidth is redistributed in proportion to the associated weights of the queues that have packets waiting. That is, when queue Q1 does not have packets waiting, the excess bandwidth is distributed proportionally to queues Q2 and Q3 so that they now receive bandwidth of 4 and 6 MB/Sec respectively.

One advantage of the WFQ technique is the end-to-end delay guarantees, i.e., each packet is guaranteed a certain rate for each packet flow in the stream. Another advantage is the underutilization of capacity when flow is particularly bursty idle time. In such case the WFQ technique facilitates the redistribution of the unused bandwidth so as to preserve work-conservation property.

The drawback of the WFQ technique inherits in its implementation. The conventional WFQ systems are based on multiple queues, this configuration is costly and complicated. Furthermore, queue based system requires to maintain the state of each packet. This requirement is not compliant with most of the communication networks. It would be therefore advantageous to provide an efficient weighted fairness bandwidth distribution system.

### SUMMARY OF THE INVENTION

These and others object that appear below are achieved by a method for fairly distributing bandwidth of a plurality of data flows by performing a weighted fair policing. The method comprises the steps of:
receiving at a queue structure a plurality of data packets coming from multiple sources, the queue structure comprises a plurality of policers connected to one data queue and each of said policers having assigned a respective excess information rate to be enforced;
computing an attenuation value for said queue, which determines current congestions for the policers to said queue; and
adaptively changing the excess information rates of the policers using the attenuation value.

According to another aspect of the invention, a weighted fair policing system is provided, for fairly distributing bandwidth of a plurality of data flows in a communication network. The weighted fair policing system contains a plurality of policers, each of said policers is capable of adaptively changing an excess information rate to be enforced. The policers are connected to a single queue and are capable to be coupled to different sources, wherein each of said plurality of sources is assigned with a different priority. The weighted fair policing system further contains a bandwidth adjustment module coupled to the queue and the plurality of policers. The bandwidth adjustment) module is capable of computing an attenuation (Attn) value for the queue which determines current congestions for the policers to the queue. The policers are further adapted to adaptively change their excess information rates (EIR) using the attenuation value (Attn).

### BRIEF DESCRIPTION OF THE DRAWINGS

FIG. 1—is a conventional WFQ system (prior art)

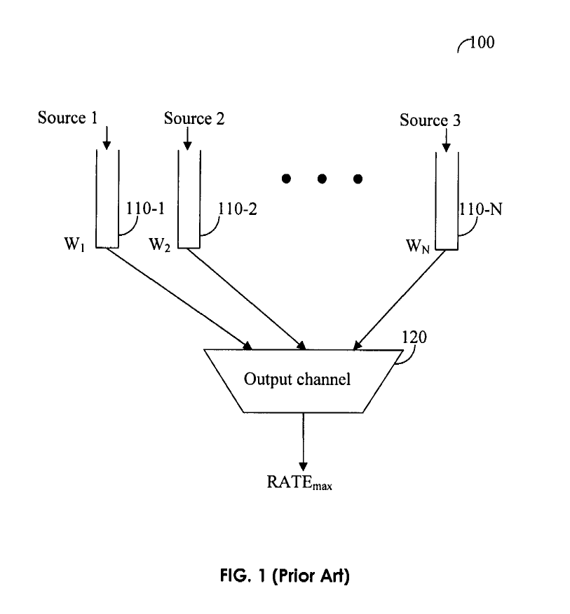

FIG. 2—is a non-limiting an exemplary block diagram of an efficient weighted fairness system that discloses one embodiment of the present invention

FIG. 3—is a non-limiting and exemplary graph of an attenuation function

FIG. 4—is an example for the operation the disclosed weighted fairness system

FIG. 5—is a non-limiting flowchart describing method for performing a weighted fair policing that discloses on embodiment of the present invention

FIG. 6—is a non-limiting an exemplary diagram of an efficient weighted fair policing system having prioritized queues that discloses one embodiment of the present invention

### DETAILED DESCRIPTION OF THE INVENTION

The present invention discloses an efficient weighted fair policing (WFP) system capable of weighted fairness bandwidth distribution. The system is based on a plurality of policers and a single queue. To achieve fairness, the rate of policed packets is adaptively controlled.

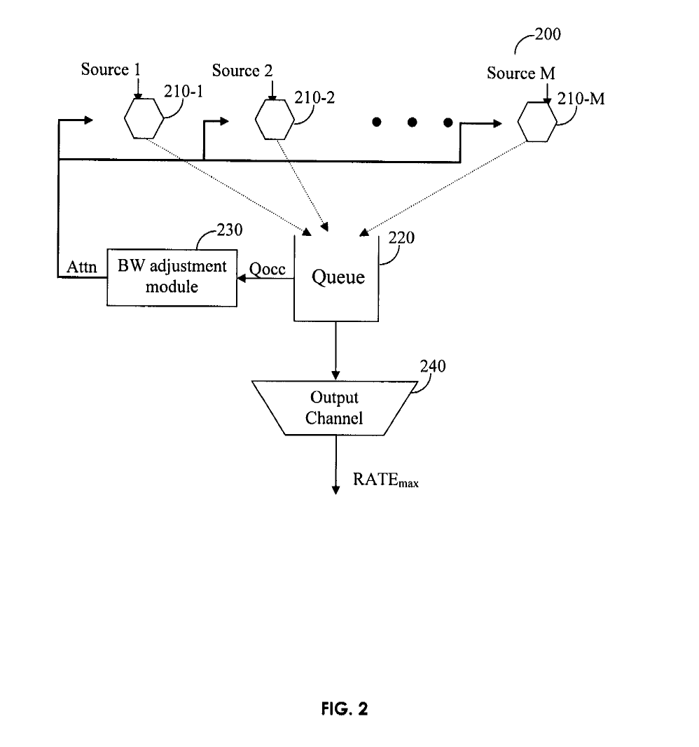

FIG. 2 shows a non-limiting and an exemplary block diagram of a WFP system 200 that discloses one embodiment of the present invention. WFP system 200 includes M policers 210-1 through 210-M connected to a single queue 220, a bandwidth adjustment module 230, and an output channel 240. Each policer 210 is parameterized by an input rate (InRate) and a maximum excess information rate (EIRₘₐₓ). A policer is a rate limiting device that rejects data packets that arrive to the policer at a instantaneous rate that is above some predefined threshold rate. Specifically, each policer 210 is capable of handling a single data flow and computing a new EIR to be enforced. Namely, packets of a respective data flow are transferred from a policer 210 to queue 220 if their instantaneous rate does not exceed the rate equal to the newly computed EIR. The new EIR is computed according to the following equation:

EIR_{new}=Attn*EIRₘₐₓ; (1)

where the “Attn” parameter is determined by an attenuation function, as described in more detail below. The EIRₘₐₓ is the maximum bandwidth that a policer can transfer. In fact, the EIRₘₐₓ are preconfigured values that determine the weighs of the WFP algorithm. Data packets flowing through the policer cannot exceed InRate. An example for a policer 210 may be found in PCT application No. PCT/112004/00781 by Zeitak, entitled “A Policer and Method for Resource Bundling”, assigned to a common assignee and hereby incorporated by reference for all that it contains.

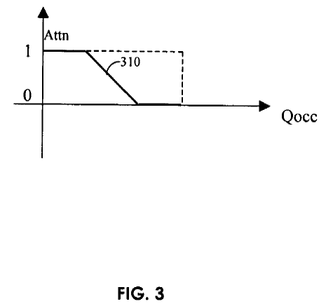

The output rate of output channel 240 is determined by a maximum allowable rate (hereinafter the “RATEₘₐₓ”) parameter. Congestion occurs whenever the total rate that the policers 210 allow is in excess of the RATEₘₐₓ. The bandwidth adjustment module 230 monitors the queue occupancy and queue ingress rate (hereinafter the “Qocc”) and computes an Attn value using the attenuation function. FIG. 3 shows a non-limiting and exemplary graph of an attenuation function 310. As seen, the Attn value ranges between 0 and 1, where a 1 value is when queue 220 is empty and a 0 value is when the queue 220 is full. The Attn value is sent to each of policers 210, which in turn calculates the EIR_{new} to be enforced. An exemplary embodiment of the attenuation function (AT) would be:

$$AT ( {Q}_{OCC} ) - \{ \begin{matrix}1 ; & if {Q}_{OCC} < Th 1 [ changed ] \\ 0 ; & if {Q}_{OCC} > Th 2 \\ \frac{Th 2 - {Q}_{OCC}}{Th 2 - Th 1} ; & if Th < {Q}_{OCC} < Th 2\end{matrix} \qquad ( 2 )$$

where, Th2 is a normalization factor that determines the maximum occupancy (in bytes) of the queue and Th1 is a threshold equals to α*Th2. The parameter α is configurable and an exemplary embodiment is set to a 0.6.

It should be appreciated by a person skilled in the art that policers are based on bandwidth, hence they cannot emulate a weight fair queuing. However, by utilizing the queue occupancy to adaptively and directly control the bandwidth of each policer, ensures fairness in respect to the maximum allowable rate. That is, by controlling the policer's bandwidth, a source transmitting at a rate that is lower than its EIRₘₐₓ may continue to deliver undistributed traffic; otherwise, the EIRₘₐₓ is reduced.

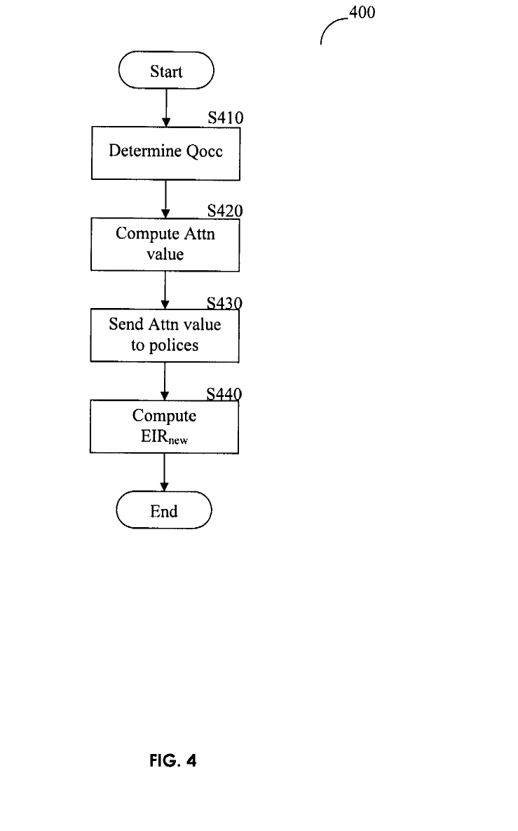

FIG. 4 shows a non-limiting flowchart 400 describing method for performing a weighted fair queuing that discloses one embodiment of the present invention. The method applies only when congestion is detected. At S410, the Qocc value of queue 220 is determined. In one embodiment the Qocc is computed as the average depth of the queue and over time. This is performed by measuring the number of stored bytes in the queue each time that a packet is inserted or removed from the queue. Averaging the queue depth provides a stable value of the Qocc. At S420, the Attn value is computed using the Qocc based on attenuation function. The Attn value may be computed using equation 2. The inventor notes that the Attn value may be slightly varied until it reaches its equilibrium point. This point is achieved when the following equation is satisfied:

$${RATE}_{max} = {\sum }_{policers} min ( InRate , Attn * {EIR}_{max} ) . \qquad ( 3 )$$

Alternatively, in the case of no congestion the equilibrium point when the following equation is satisfied:

$${RATE}_{max} < {\sum }_{policers} min ( InRate , {EIR}_{max} ) . \qquad ( 4 )$$

At S430, the Attn value is sent to each of policers 210. The Attn value is used for computing and enforcing the EIR_{new} on incoming packets as shown at S440. The EIR_{new} may be computed using equation 1.

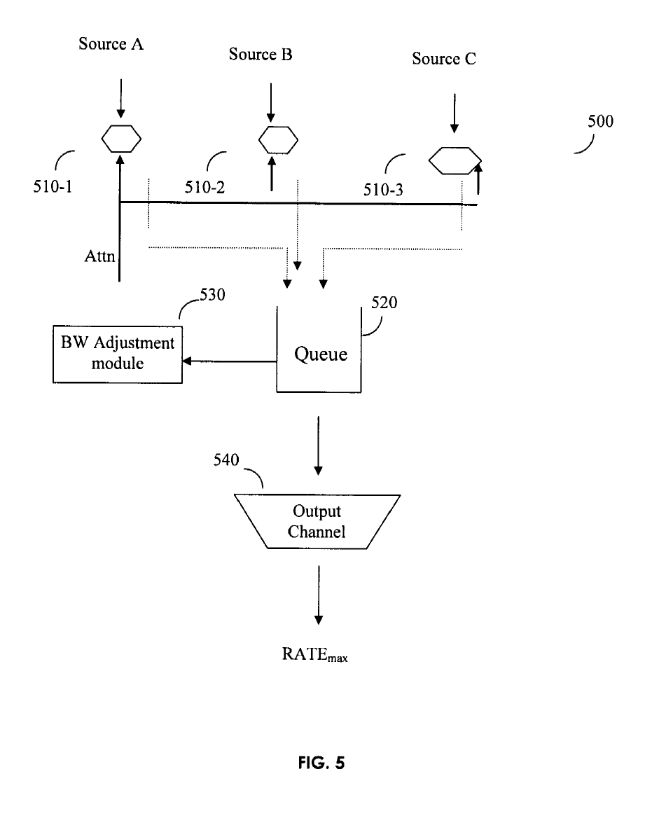

Following is a non-limiting example describing the weighted fair queuing performed by the present invention. FIG. 5 shows an exemplary WFP system 500 that includes three policers 510-1, 510-2, and 510-3 connected to a queue 520. Each of policers 510-1, 510-2, and 510-3 is configured with an EIRₘₐₓ value that equals, for example, to 30 MB/Sec. A source A transmits packets through policer 510-1 at a rate that equals, for example, to 10 MB/Sec; a source B transmits packets through policer 510-2 at a rate that equals to, for example, 20 MB/Sec; and, the output rate of source C is, for example, 30 MB/Sec. The RATEₘₐₓ of output channel 540 is, for example, 30 MB/Sec. It is clear that in such exemplary configuration congestion occurs.

To fairly schedule packets of the input sources, the Attn value in computed. In the example above the equilibrium point is achieved when the Attn value is ⅓. This value is sent to policers 510-1, 510-2 and 510-3 that computes the EIR_{new} values. The computed EIR_{new} value of all policers 510-1, 510-2, and 510-3 equals to 10 MB/Sec. Policers 510 cannot transmit packets at a rate that exceeds the computed EIR_{new}, and therefore the policers together cannot deliver packets at a rate that is above RATEₘₐₓ.

It should be noted that the Attn is adaptively changed according to traffic rates of the input sources. For instance, if source A stops transmitting packets then the depth of queue 520 reduces and therefore a new Attn value is generated. Here, the equilibrium is achieved when Attn value equals to ½. Accordingly, the EIR_{new} values of policers 510-1 and 510-2 are set to 10 MB/Sec.

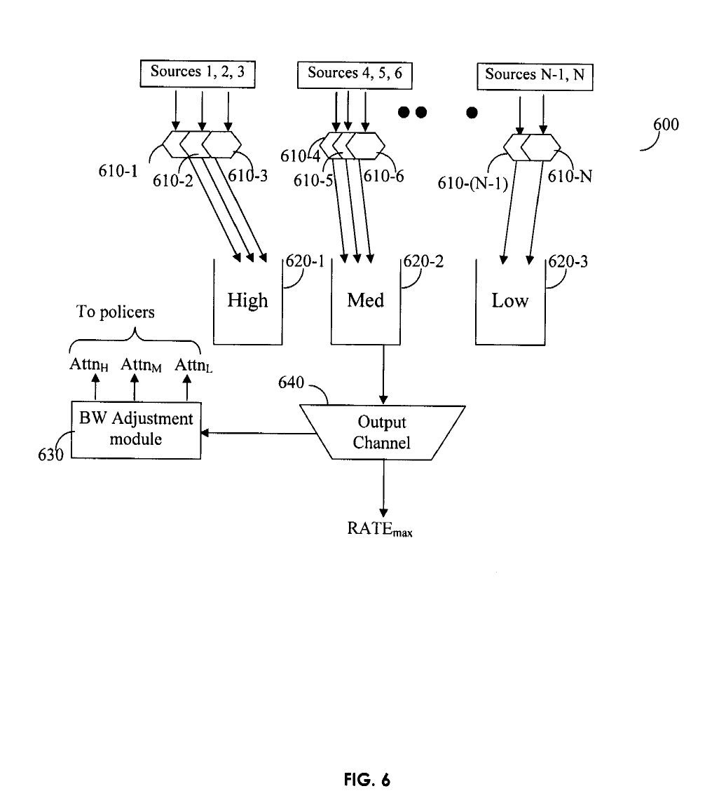

In another embodiment of the present invention the principles of WFP technique disclosed herein can be utilized in systems having a plurality of queues, where each queue has its own priority. FIG. 6 shows an exemplary system 600 that includes N policers 610-1 through 610-N connected to queues 620-1, 620-2, and 620-3. The priorities assign to queue 620-1, 620-2, and 620-3 are high, low, and medium respectively. The priority determines the waiting time of packets in a queue, i.e., packets in a high priority queue are queued for relatively less time than packets in a low priority queue. In this embodiment, a different attenuation function is associated with each queue. The Attn function of low priory queue 620-3 (AT_{L}) is based on the Qocc of that queue, i.e., AT_{L}=F[Qocc_{L}]. The Attn function of medium priory queue 620-2 (AT_{M}) is based on the Qocc of that queue (Qocc_{M}) and on the occupation of CIR bytes QoccLC in the low priory queue 620-3, i.e., AT_{M}=F[Qocc_{M}, QoccLC]. The Attn function of high priority queue 620-1 (AT_{M}) is based on the Qocc of queue 620-1 as well as on the occupation of CIR bytes QoccLC in the the low priority queue 620-3 and the occupation of CIR bytes QoccMC in the medium priory queue 620-3, i.e., AT_{M}=F[Qocc_{M}, QoccMC, QoccLC]. The use of the CIR occupation values of lower priority queues to set the value of higher priority queues is performed in order to deliver packets having a committed information rate (CIR) from lower priority queues. In fact, the Qocc_C of the low and medium priority queues is a function of the number of CIR bytes in the respective queue.

1. A method for fairly distributing bandwidth of a plurality of data flows by performing a weighted fair policing, said method comprises the steps of:
receiving at a queue structure a plurality of data packets coming from multiple sources, wherein the queue structure comprises a plurality of policers connected to one data queue and each of said policers having assigned a respective excess information rate (EIR) to be enforced;
computing an attenuation (Attn) value for said queue, said attenuation value determines current congestions for the policers to said queue; and
adaptively changing the excess information rates (EIR) of said policers using said attenuation value.

2. The method of claim 1, wherein computing said Attn value further comprises the step of:
monitoring occupancy of a queue; and
using the queue occupancy and an attenuation function for determining said attenuation value.

3. The method of claim 2, wherein monitoring the queue occupancy comprises:
measuring an average depth of the queue.

4. The method of claim 1, wherein adaptively changing said EIR further comprises:
receiving said attenuation value at a plurality of policers; and
by each of said plurality of policers, computing a new EIR value to be enforced.

5. A weighted fair policing system for fairly distributing bandwidth of a plurality of data flows in a communication network, said weighted fair policing system comprises:
a plurality of policers, each of said policers is capable of adaptively changing an excess information rate to be enforced, wherein the plurality of policers are connected to a single queue;
said plurality of policers being capable to be coupled to different sources, wherein each of said plurality of sources is assigned with a different priority; and
a bandwidth adjustment module coupled to said queue and said plurality of policers, said bandwidth adjustment module is capable of computing an attenuation (Attn) value for said queue which determines current congestions for the policers to said queue;
wherein said policers are adapted to adaptively change their excess information rates (EIR) using said attenuation value (Attn).

6. The WFP system of claim 5, wherein the Attn value of a higher priority queue is based at least on the Attn value of a lower priority queue.

7. The WFP system of claim 5, wherein said Attn value is a function of a number of committed information rate (CIR) packets in a respective queue.

8. The WFP system of claim 5, wherein the EIR of each of said plurality of policers is changed in a linear proportion to said Attn value.
